(19) United States
(12) Patent Application Publication
(10) Pub. No.: US 2026/0023048 A1
(43) Pub. Date: Jan. 22, 2026

(54) ULTRASOUND PROBE HOLDING ASSEMBLY

(71) Applicant: EBAMed SA, Geneva (CH)

(72) Inventors: Tristan BENOIT, Yvoire (FR); Christian BOCHUD, Bienne (CH); Saskia CAMPS, Prangins (CH); Adriano GARONNA, Geneva (CH); Stuart OLSTAD, Marcell, MN (US)

(73) Assignee: EBAMed SA, Geneva (CH)

(21) Appl. No.: 19/107,492

(22) PCT Filed: Aug. 29, 2023
(86) PCT No.: PCT/IB2023/058539

§ 371 Date: Feb. 27, 2025

(30) Foreign Application Priority Data
Aug. 29, 2022 (WO) PCT/IB2022/058083

(51) Int. Cl. G01N 29/22; G01N 29/24

(52) U.S. Cl. CPC G01N 29/226; G01N 29/2481

(57) ABSTRACT

Systems and methods for hands-free operation of ultra-sound probes. Pressure is maintained between the ultrasound probe and a subject without need of an externally applied force (e.g., without hand, robotic arm, or other external force application). Flexible components are utilized that largely conform to the contour of the body for reduced distortion relative to rigid components used in conventional systems. Some embodiments provide a handle for probe orientation adjustment that can be selectively removed during hands-free operation to reduce gravitational moments. Other provisions include integrated marking assembly for tracking probe location, wireless information capability (e.g., RFID), and integrated ECG patches. Various embodiments of the disclosure may include an ergonomic clasping arrangement that may provide a mechanical advantage for easy decoupling and recoupling of the probe from anchored moorings. A full range of pitch adjustment at the contact interface may be provided with or without a disclosed gimbal mounting.

### RELATED APPLICATIONS

This patent application claims the benefit of International Patent Application No. PCT/IB2022/058083, filed Aug. 29, 2022, the disclosure of which is hereby incorporated by reference herein in its entirety.

### FIELD OF THE DISCLOSURE

The present application is directed generally to ultrasound systems and more specifically to ultrasound probe assemblies.

### BACKGROUND

Ultrasound imaging has found many applications in modern medical procedures and treatment. A fundamental aspect of ultrasound imaging of internal regions of a human or animal subject is the application of an appropriate force at a contact interface between an associated ultrasound probe and the subject. Also, in the context of a modern clinical setting such as an operating room, a “hands-free” application of the ultrasound probe is generally preferred, wherein the probe is held in the same place as with the hand and applies the same pressure as with the hand but without the need for manually performing these tasks. Assemblies and techniques that enhance hand-operated emulation in a hands-free application for a variety of applications would be welcomed.

### SUMMARY OF THE DISCLOSURE

Various embodiments of the disclosure enable clinicians to safely and effectively perform prolonged hands-free ultrasound imaging within a patient with the ultrasound probe mounted to any body part and with the patient in any position (e.g., laying down, seated, standing). Systems and methods are disclosed for holding the ultrasound probe in position on the patient and for applying pressure between the ultrasound probe and the selected body part without need of an externally applied force (e.g., without hand, robotic arm, or other external force application). Geometries of the components of the system that augment these aspects are also disclosed.

The disclosed systems and techniques can be applied to any part of the body for diagnostic ultrasound imaging, ultrasound-based image guidance in surgical procedures or ultrasound-based treatments such as high-intensity focused ultrasound (HIFU). Any of a variety of ultrasound imaging probes and modalities may be utilized, including but not limited to single plane, matrix, convex, linear, or other probe types for Doppler, clastography, M-mode and other imaging modes. In one embodiment, the system is applied to phased array bi-plane B-mode ultrasound imaging for guidance in cardiac radioablation treatments.

Various embodiments of the disclosure utilize flexible components that largely conform to the contour of the body for reduced distortion relative to rigid components of conventional systems. The disclosed system securely mounts the probe to the patient without need for structures that generate rigid pressure points proximate the contact interface and attendant distortion of the image field. The disclosed system may operate without need for clastic straps that would otherwise generate strong radial force vectors on the holder assembly. Some embodiments of the disclosure enable the retention force of the probe to be independent of the pressure generated at the contact interface, providing a handle for probe orientation adjustment that can be selectively removed during hands-free operation to reduce gravitational moments, routing of the probe cabling parallel to the contact interface, and/or provisions for an integrated marking assembly for motion tracking of the probe location.

Various embodiments of the disclosure may include an ergonomic clasping arrangement that may provide a mechanical advantage for casy decoupling and recoupling of the probe from anchored moorings. Some embodiments advantageously provide a gimbal structure for a full range of adjustment of the pitch angle of the probe at the contact interface. A novel probe suspension assembly eliminates the need for the gimbal structure to contact the patient during operation. Still other embodiments can effect a pitch angle adjustment without need of a gimbal structure.

Conventional systems that provide the ability to secure and track the movement of ultrasound probes often require multiple components. Such multiple component probe assemblies can be difficult to use, as the components need to be arranged relative to each other while being adjusted to scan the desired target zone. Many conventional multiple component probe systems require handling by an operator with two hands or participation of more than one operator. Various embodiments of the disclosed system integrate the components for case of placement and adjustment of the components and hands-free operation.

“Hands-free” ultrasound imaging techniques are known in the art that eliminate the need for handling the ultrasound probe during scanning. See, e.g., International Patent Application No. WO 2017/052363 to Tchang, et al., U.S. Patent Application Publication No. 2020/0015780 to Geelen et al., and U.S. Patent Application Publication No. 2014/0107435 to Sharf et al. Such conventional hands-free systems have various limitations and shortcomings in common, including mounting interfaces with the patient that are rigid or rigidly backed that can produce small, high-pressure points on the skin that can produce patient discomfort when mounted for prolonged periods, and can distort the subject silhouette in the presence of obese subjects. Other conventional systems and methods apply force to the ultrasound probe with articulated mechanical or robotic arms, which occupy a considerable footprint around a contact interface of the probe. Such increased footprint can limiting the utility of the ultrasound system in applications where the position of the probe needs to be tracked in space (e.g., with optical cameras), where medical staff need to perform activity in close vicinity to the contact interface, and/or when a therapeutic/imaging machine is required to operate in close vicinity to the contact interface.

The aforementioned functional aspects of the various and sundry embodiments of the disclosure address the limitations and shortcomings of conventional probe holding assemblies. The disclosed probe holder assembly is well suited for, but not limited to, use in non-invasive beam therapy systems such as disclosed at International Patent Application Nos. WO 2022/136925 to Camps et al., WO 2021/094824 to Camps et al., and WO 2019/096943 to Garonna et al., which are owned by the owners of the present patent application.

Structurally, various embodiments of the disclosed probe holder assembly incorporate a probe housing for containment of a probe, the probe housing including a proximal end and a distal end separated by a side wall having an exterior surface. An anchor assembly including a compliant cover portion that defines an aperture for passage of the distal end of the probe housing, the aperture defining and being co-linear with a positioning axis, an adhesive layer that covers the distal face of the compliant cover portion, and a plurality of ties coupled to and extending in a proximal direction from the compliant cover portion. A probe suspension assembly for coupling to the probe housing and to the anchor assembly, including a lock ring that defines and is co-linear with a ring axis and having an interior surface configured to engage the exterior surface of the side wall of the probe housing to secure the lock ring to the probe housing, and one or more clasps for selectively grasping the plurality of ties of the anchor assembly to exert and maintain the plurality of ties in tension, the one or more clasps being coupled to the lock ring. The probe suspension assembly is separated from the compliant cover portion by the plurality of ties.

In some embodiments, the anchor assembly includes a plurality of tie anchors attached to the compliant cover portion, cach of the plurality of tie anchors being connected to a corresponding one of the plurality of ties. The interior surface of the lock ring and the external surface of the probe housing may be configured to statically secure the lock ring to the probe housing by a frictional force. In some embodiments, the frictional force is of a magnitude that is selectively overcome by hand, for example by a torsion applied to the probe housing about the ring axis that exceeds a range of 1 to 2.5 Newton-meters inclusive. The probe housing may be configured for coupling with the lock ring of the probe suspension assembly proximate a distal end of the probe housing. In some embodiments, the one or more clasps are adjustable along the plurality of ties for definition of a pitch angle of the ring axis relative to the positioning axis.

In some embodiments, the interior surface of the lock ring and the exterior surface of the probe housing define complementary profiles for capture of the probe housing within the probe suspension assembly. The complementary profiles of the exterior surface of the side wall of the probe housing and the interior surface of the lock ring of the probe suspension assembly may define arcuate profiles. The arcuate profile of the exterior surface of the side wall may be convex and the arcuate profile of the interior surface of the lock ring concave. In some embodiments, the arcuate profiles define spherical segments. The arcuate profiles may cooperate to enable orienting the probe housing at a selected pitch angle relative to the ring axis.

In some embodiments, the probe is an ultrasound probe. The distal end of the probe housing may include an ultrasound lens for directing ultrasound waves emitted from the ultrasound probe. The probe housing may be injection molded. In some embodiments, the lens includes a polyamide material. The probe housing may include a feedthrough for wires of the probe. In some embodiments, the feedthrough is disposed proximate the proximal end of the probe housing.

In some embodiments, the probe holder assembly comprises an information tag coupled to the compliant cover portion. In some embodiments, an electrocardiogram (ECG) sensor coupled to the compliant cover portion.

Various embodiments of the disclosure include probe holder assembly comprising a probe suspension assembly for coupling with a probe, including: a lock ring that defines and is co-linear with a ring axis and having an interior surface configured to capture and secure the probe; and one or more clasps for selectively grasping a plurality of ties, the one or more clasps being coupled to the lock ring. The one or more clasps may include an actuation mechanism having a lever that engages the at least one of the plurality of ties, the lever being configured for selective disengagement from the at least one of the plurality of ties. In some embodiments, the lever is pivotally mounted to the actuation mechanism.

In some embodiments, the probe suspension assembly includes a biasing element configured to hold the lever in engagement with the at least one of the plurality of ties. The lever may include a nib that engages a serrated surface of the at least one of the plurality of ties. In some embodiments, the lever secures a serrated surface of the at least one of the plurality of ties against a nib disposed on the actuation mechanism.

In some embodiments, the lock ring is continuous. In other embodiments, the lock ring is bifurcated to define a first lock ring segment and a second lock ring segment. The first lock ring segment and the second lock ring segment may be pivotally connected to each other. In some embodiments, the probe is rotatable within the lock ring when the probe suspension assembly is in a partially closed configuration, and the probe is maintained in a fixed angular relationship within the lock ring when the probe suspension assembly is in a fully closed configuration. The probe suspension assembly may include a catch that extends from the first lock ring segment to the second lock ring segment for interlocking the first lock ring segment and the second lock ring segment in a fully closed configuration to statically secure the probe suspension assembly to the probe. In some embodiments, the catch includes a finger loop for hand actuation. The catch may be pivotally mounted to the first lock ring segment and selectively attachable to the second lock ring segment. In some embodiments, the catch includes a notch and a protrusion.

In some embodiments, in a partially closed configuration, the notch engages a first registration surface of the protrusion to define a first maximum separation distance between a midpoint of the first lock ring segment and a midpoint of the second lock ring segment. In a fully closed configuration, the notch may engage a second registration surface of the protrusion to define a second maximum separation distance between the midpoint of the first lock ring segment and the midpoint of the second lock ring segment. In some embodiments, the first maximum separation distance is greater than the second maximum separation distance. In the partially closed configuration, the probe may be captured by and rotatable within the lock ring, and in the fully closed configuration, the probe may be captured by and in a fixed angular relationship with the lock ring.

In some embodiments, the probe is selectively coupled to the lock ring in a twist lock arrangement. The twist lock arrangement may include a lock pin that mates with a lock groove. In some embodiments, the probe is contained in a probe housing. The probe housing may include the lock pin and the lock ring may define the lock groove.

Various embodiments of the disclosure include probe holder assembly comprising an anchor assembly including: a compliant cover portion that defines an aperture that defines and is concentric about a positioning axis; a plurality of tie anchors coupled to the compliant cover portion; and a plurality of ties, cach being connected to a corresponding one of the plurality of tie anchors, the plurality of ties extending in a proximal direction from the plurality of tie anchors. The compliant cover may be a meshed configuration. The compliant cover may be one of a cloth material, a polymer material, and a rubber material. In some embodiments, the ties of the plurality of ties are cable ties. The plurality of tie anchors may extend through the compliant cover portion in a proximal direction. In some embodiments, the plurality of tie anchors are coupled to a distal face of the compliant cover portion.

The probe holder assembly may comprise an adhesive layer that covers a distal face of the compliant cover portion. The adhesive layer may cover distally facing surfaces of the plurality of tie anchors. In some embodiments, the probe holder assembly comprises a probe suspension assembly for coupling to a the anchor assembly and including one or more clasps for selectively grasping the plurality of ties of the anchor assembly to exert and maintain the plurality of ties in tension. Each of the one or more clasps includes an actuation mechanism may have a lever that engages the at least one of the plurality of ties, the lever being configured for selective disengagement from the at least one of the plurality of ties for freely positioning the probe suspension assembly along the positioning axis in a proximal direction and a distal direction.

In some embodiments, the probe suspension assembly including a lock ring for coupling to a probe, the one or more clasps being coupled to the lock ring. The probe holder assembly may comprise a marker assembly including a body portion defining a body axis that extends through a proximal end and a distal end, the distal end of the body portion being mounted to the proximal end of the probe housing, and a plurality of markers coupled to the body portion, the markers being configured for viewing with a camera.

Various embodiments of the disclosure include a probe holder assembly comprising: a probe housing for containment of a probe, the probe housing including a proximal end and a distal end separated by a side wall having an exterior surface; and a marker assembly. The marker assembly may include a body portion defining a body axis that extends through a proximal end and a distal end, the distal end of the body portion being mounted to the proximal end of the probe housing, and a plurality of markers coupled to the body portion, the markers being configured for viewing with a camera. The probe housing and the marker assembly may be configured for coupling in a fixed angular relationship about the body axis. The coupling may include a plurality of dowel pins that are mounted to one of the probe housing and the marker assembly for insertion into corresponding apertures that are defined on an other of the marker assembly and the probe housing. In some embodiments, the plurality of markers are configured for one of active emission and passive reflection, and may be configured for detection by an infrared camera. In some embodiments the probe holder assembly comprises a handle assembly having a distal end configured for selective coupling to the proximal end of the marker assembly.

Various embodiments of the probe holder assembly disclosed herein comprise: a marker assembly including a body portion defining a body axis that extends through a proximal end and a distal end, the distal end of the body portion being mounted to the proximal end of the probe housing, and a plurality of markers coupled to the body portion, the markers being configured for viewing with a camera; and a handle assembly having a distal end configured for selective coupling to the proximal end of the marker assembly. The marker assembly may include a first connector at the proximal end of the body portion. In some embodiments, the handle assembly includes a second connector at the distal end of the handle assembly. When fully engaged, the first connector and the second connector may maintain the marker assembly and the handle assembly in a fixed axial and rotational relationship. The first connector may be unitary with the body portion of the marker assembly. In some embodiments, the first connector and the second connector include a polygonal interface to maintain the rotational relationship. In some embodiments, the handle assembly includes a stem portion housed inside a guard portion, the stem portion being configured to translate axially for coupling the second connector to the first connector. The first connector may be female and the second connector male.

Various embodiments disclosed herein include a method for positioning a probe on a patient for hands-free operation, comprising: providing a kit including an anchor assembly, a probe suspension assembly, and a probe housing; and providing instructions on a tangible, non-transitory medium, the instructions including: adhesively coupling a compliant cover portion of the anchor assembly to the anatomical location of a patient; depressing opposed plunger mechanisms on the probe suspension assembly to freely position the probe housing along a positioning axis of the anchor assembly; and releasing the opposed plunger mechanisms on the probe suspension assembly to couple the probe suspension assembly to the anchor assembly when the probe housing is in a desired contact condition with an anatomical location of a patient. The instructions provided in the step of providing instructions may include, during the step of depressing the opposed plunger mechanisms, rotating the probe suspension assembly about a lateral axis of the probe suspension assembly to define a pitch angle of the probe housing relative to the positioning axis, the lateral axis being orthogonal to an actuation axis of the opposed plunger mechanisms.

In some embodiments, the instructions provided in the step of providing instructions includes, during the step of depressing the opposed plunger mechanisms, rotating the probe suspension assembly about a central axis of the probe suspension assembly to define a pitch angle of the probe housing relative to the positioning axis, the central axis being orthogonal to an actuation axis of the opposed plunger mechanisms. The instructions provided in the step of providing instructions may include, during the step of depressing the opposed plunger mechanisms, rotating the probe suspension assembly about a lateral axis of the probe suspension assembly to define the pitch angle of the probe housing relative to the positioning axis, the lateral axis being orthogonal to an actuation axis of the opposed plunger mechanisms. In some embodiments, the step of releasing the opposed plunger mechanisms includes coupling to a plurality of ties to hold the ties in tension. The probe housing may be coupled to the probe suspension assembly in the step of providing the kit. In some embodiments, the instructions in the step of providing instructions includes coupling the probe housing to the probe suspension assembly.

Various embodiments disclosed herein include a method orienting a probe on a patient for hands-free operation, comprising: providing a kit including a probe suspension assembly, and a probe housing; and providing instructions on a tangible, non-transitory medium, the instructions including: configuring a lock ring of the probe suspension assembly in a partially closed configuration; rotating the probe housing within the probe suspension assembly into a desired orientation; and configuring the lock ring in a fully closed configuration to secure the probe housing in the desired orientation. The step of rotating the probe housing may include defining a non-zero pitch angle between a probe axis of the probe housing and a ring axis of the probe suspension assembly. In some embodiments, the method comprises executing the instructions provided in the step of providing instructions.

### BRIEF DESCRIPTION OF THE DRAWINGS

FIG. 1 is a perspective view of a probe holder assembly according to an embodiment of the disclosure;

FIG. 2 is a side elevational sectional view of the probe holder assembly of FIG. 1 according to an embodiment of the disclosure;

FIG. 3 is a front elevational sectional view of the probe holder assembly of FIG. 1 according to an embodiment of the disclosure;

FIG. 4 is a proximal perspective view of a probe holder assembly kit including the components of the probe holder assembly of FIG. 1 according to an embodiment of the disclosure;

FIG. 5 is a distal perspective view of the probe holder assembly kit of FIG. 4 according to an embodiment of the disclosure;

FIG. 6 is a proximal perspective view of an anchor assembly for the probe holder assembly of FIG. 1 according to an embodiment of the disclosure;

FIG. 7 is a distal perspective view of the anchor assembly of FIG. 6 according to an embodiment of the disclosure;

FIG. 8 is a partially exploded view of the anchor assembly of FIG. 6 according to an embodiment of the disclosure;

FIG. 9 is a proximal perspective view of a probe suspension assembly for the probe holder assembly of FIG. 1 with a closure removed to reveal a clasp actuation mechanism according to an embodiment of the disclosure;

FIG. 10 is a distal perspective view of the probe suspension assembly of FIG. 9 according to an embodiment of the disclosure;

FIG. 11 is a plan cutaway view of the probe suspension assembly of FIG. 9 in a partially closed configuration according to an embodiment of the disclosure;

FIG. 12 is the plan cutaway view of the probe suspension assembly of FIG. 11 in a fully closed configuration according to an embodiment of the disclosure;

FIG. 13 is an enlarged view of the cutaway at inset XIII of FIG. 11 according to an embodiment of the disclosure;

FIG. 14 is an enlarged view of the cutaway at inset XIV of FIG. 12 according to an embodiment of the disclosure;

FIG. 15 is a plan view of an alternative probe suspension assembly for use with the probe holder assembly of FIG. 1 according to an embodiment of the disclosure;

FIG. 16 is an enlarged view of the clasp actuation mechanism of FIG. 9 according to an embodiment of the disclosure;

FIG. 17 is a sectional view of the probe suspension assembly at plane XVII-XVII of FIG. 12 according to an embodiment of the disclosure;

FIG. 18 is an enlarged partial sectional view at inset XVIII of FIG. 17 according to an embodiment of the disclosure;

FIG. 19 is a plan view of the clasp actuation mechanism of FIG. 16 in an actuated state according to an embodiment of the disclosure;

FIG. 20 is a proximal perspective view of a probe housing for the probe holder assembly of FIG. 1 according to an embodiment of the disclosure;

FIG. 21 is a distal perspective view of the probe housing of FIG. 20 according to an embodiment of the disclosure;

FIG. 22 is a proximal perspective view of a probe housing having a right cylindrical exterior surface according to an embodiment of the disclosure;

FIG. 23 is a sectional view of a lock ring for coupling to the probe housing of FIG. 22 according to an embodiment of the disclosure;

FIG. 24 is a proximal perspective view of a marker assembly for the probe holder assembly of FIG. 1 according to an embodiment of the disclosure;

FIG. 25 is a distal perspective view of the marker assembly of FIG. 24 according to an embodiment of the disclosure;

FIG. 26 is a front elevational view of a sub-assembly of the probe housing of FIG. 20 coupled to the marker assembly of FIG. 24 according to an embodiment of the disclosure;

FIG. 27 is a side elevational view of the sub-assembly of the probe housing and marker assembly of FIG. 26 according to an embodiment of the disclosure;

FIG. 28 is a proximal perspective view of a handle assembly for the probe holder assembly of FIG. 1 according to an embodiment of the disclosure;

FIG. 29 is a distal perspective view of the handle assembly of FIG. 28 according to an embodiment of the disclosure;

FIG. 30 is an elevational view of the handle assembly of FIG. 28 with a portion of a casing removed according to an embodiment of the disclosure;

FIG. 31 is an elevational sectional schematic of a first aggregate center of gravity for rotatable components of the probe holder assembly of FIG. 1 according to an embodiment of the disclosure;

FIG. 32 is an elevational sectional schematic of a second aggregate center of gravity for rotatable components of the probe holder assembly of FIG. 31 without the handle assembly according to an embodiment of the disclosure; and

FIG. 33 is a partial elevational sectional view of a probe holder assembly utilizing tie adjustments to effect a pitch angle according to an embodiment of the disclosure.

### DETAILED DESCRIPTION

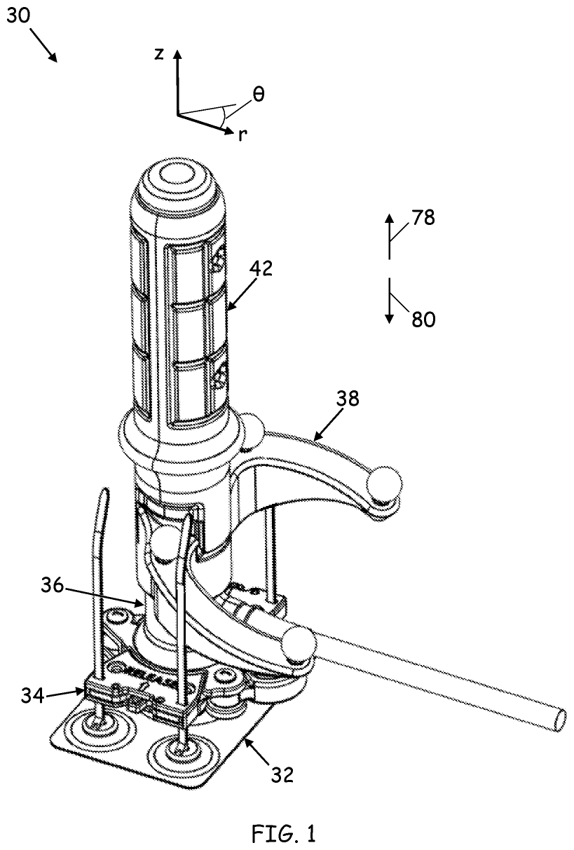

Referring to FIGS. 1 through 5, a probe holder assembly 30 is depicted according to an embodiment of the disclosure. The probe holder assembly 30 includes an anchor assembly 32, a probe suspension assembly 34, a probe housing 36, a marker assembly 38, and a handle assembly 42. The components of the probe holder assembly 30 may be manufactured using only non-metallic materials, such as polymers, rubbers, and cloth.

An r-θ-z coordinate system is depicted in FIG. 1 that serves as the basis for directional and positional nomenclature herein. “Axial” refers to a direction parallel to the z-coordinate, with “proximal” being in the positive direction and “distal” being in the negative direction along the z-coordinate, and “lateral” being a direction that is orthogonal to the z-coordinate. “Radial” refers to a direction along r-coordinate, with the modifiers “inward” and “outward” being toward and away from the z-coordinate, respectively. “Tangential” refers to a direction that is congruent with the θ-coordinate.

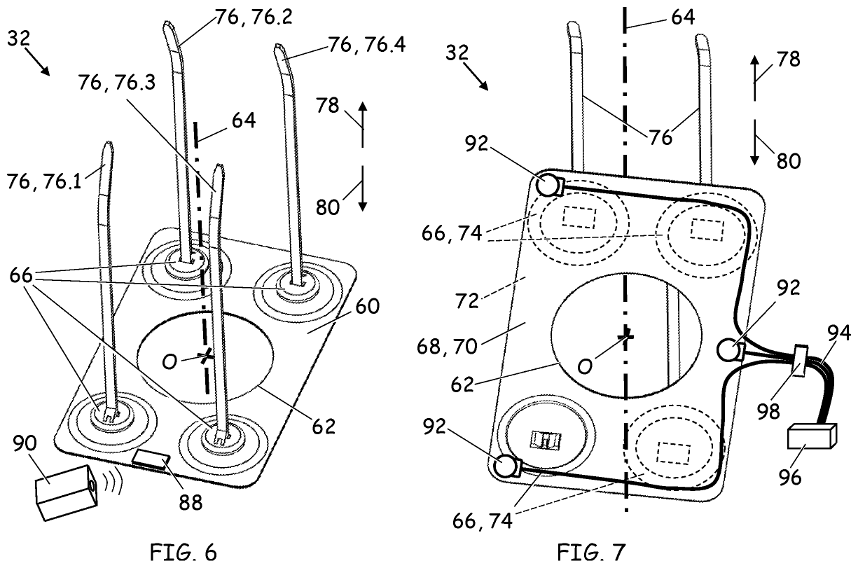

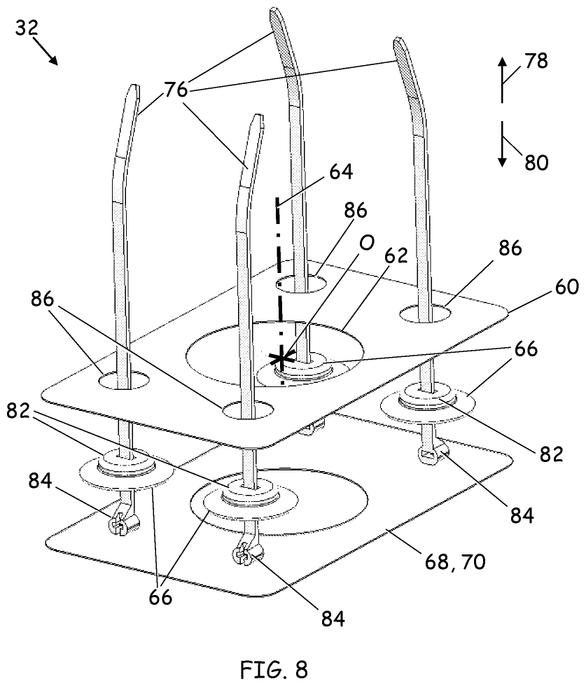

Referring to FIGS. 6 through 8, the anchor assembly 32 is depicted in greater detail according to an embodiment of the disclosure. The anchor assembly 32 includes a compliant cover portion 60 that defines an aperture 62, the aperture 62 defining and being concentric about a positioning axis 64. For purposes of illustration, the positioning axis 64 is assigned an origin O at the center of the aperture 62. A plurality of tie anchors 66 are coupled to the compliant cover portion 60. An adhesive layer 68 may cover a distal face 72 of the compliant cover portion 60 and may also cover distally facing surfaces 74 of the tie anchors 66. The anchor assembly 32 includes a plurality of ties 76, cach being connected to a corresponding one of the plurality of tie anchors 66. The plurality of ties 76 extend in a proximal direction 78.

In some embodiments, the adhesive layer 68 is a sheet 70 that has adhesive deposited on both sides with a distal protective barrier (not depicted) that can be peeled away for mounting the anchor assembly 32 to a patient. Alternatively, the adhesive layer 68 may be established by coating the distal face 72 of the compliant cover portion 60 when mounting the anchor assembly 32 to the patient.

In some embodiments, the tie anchors 66 are coupled to the distal face 72 of the compliant cover portion 60. Each tie anchor 66 may define a receptacle 82 that receives a head portion 84 of the corresponding tie 76 attached thereto. The tie anchors 66 may extend through the compliant cover portion 60 in the proximal direction 78 and a distal direction 80, for example through-apertures 86 formed in the compliant cover portion 60. The plurality of ties 76 may be cable ties (depicted), commonly referred to as ZIP-TIES. In some embodiments, the compliant cover portion 60 is a meshed configuration, for example of a cloth material, a polymer material, or a rubber material.

In some embodiments, an information tag 88 is integrated into the anchor assembly 32. Information stored on the information tag 88 may be received by a wireless communication device 90 (FIG. 6). In some embodiments, the information tag 88 includes baseline information about the anchor assembly 32, such as a unique identifier, manufacturer, model, and fabrication history. Such information may be encrypted, for example, on a bar code tab that either contains the baseline information or is associated therewith in a remote database. The remote database may be updated to include use information, for example, the time and date of use, the type of use (e.g., for actual vs. simulated treatment), and/or anonymized patient identification.

The information tag 88 may include local electronic memory capability that can accommodate both reading therefrom and writing thereto, such as provided by a radio frequency identification (RFID) chip or a near field communication (NFC) tag and an appropriate wireless communication device 90. The read/write capability enables the local electronic memory to be updated to include the use information. In some embodiments, the storage capability of the local electronic memory is in a range of 128 to 512 bits inclusive.

In some embodiments, one or more electrocardiogram (ECG) sensor(s) 92 are integrated into the anchor assembly 32 (FIG. 7). A cable assembly 94 may be connect the sensor(s) 92 to an ECG module 96 for processing the signals from the ECG sensor(s) 92. In some embodiments, leads from the cable assembly 94 are routed under or through the compliant cover portion 60 for connection to the ECG sensor(s) 92. The ECG sensor(s) 92 are arranged for operative coupling with the patient when the compliant cover portion 60 is adhered to the patient. In some embodiments, the number of ECG sensors 92 integrated into the anchor assembly 32 is in a range from 1 to 6 sensors inclusive. The ECG sensor(s) 92, like the anchor assembly 32, may be disposable.

The ECG sensor(s) 92 may be combined and associated with the information tag 88 for tracking use information. Alternatively or in addition, the cable assembly 94 may include an electronic read/write memory device 98, such as an erasable programmable read-only memory (EPROM). The memory device 98 may be accessed through the ECG module 96 or other processor via the cable assembly 94 to augment or store the same baseline and/or use information as the information tag 88. In some embodiments, the memory device 98 has a capacity of up to 20 kilobits.

Functionally, the mechanical flexibility of the compliant cover portion 60 enables complete and uninterrupted contact of the adhesive layer 68 over any anatomical contour, thereby enhancing the strength of the bond to the patient. The compliance of the cover portion 60 reduces deformation of the anatomical contour relative to a rigid mounting interface for improved fine pressure management. The enhanced bond also enables the anchor assembly to remain fixed to the patient for extended periods of time. The presence of the compliant cover portion 60 sans the remaining components of the system enables visualization of the ultrasound probe position on computer tomography (CT) scans without the presence of the ultrasound probe, thus eliminating potential artifacts on the CT images caused by the ultrasound probe. The compliant cover portion 60 can act as a template for easy marking of the skin of the patient for later repositioning or remounting of the probe holder assembly 30.

The information tag 88 facilitates historical tracking of the anchor assembly 32. In one example, the anchor assembly 32 is removed from packaging and the information tag 88 read by the wireless communication device 90. The use information may be updated, for example in remote memory or, for information tags 88 so equipped, on the local memory. The use information may facilitate, for example, assurance that the anchor assembly 32 is utilized in an appropriately disposable manner or is not used for different patients. The information tag 88 may also be used to track the history of other components of the probe holder assembly 30.

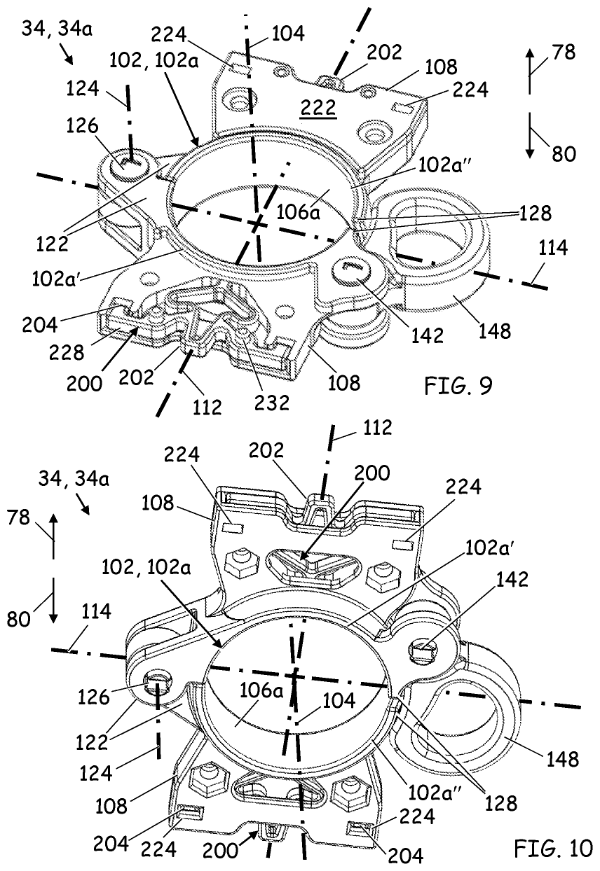

Referring to FIGS. 9 and 10, a probe suspension assembly 34 is depicted according to an embodiment of the disclosure. The probe suspension assembly 34 includes a lock ring 102 that defines and is co-linear with a ring axis 104. The lock ring 102 includes an interior surface 106 that faces radially inward towards the ring axis 104. The probe suspension assembly 34 also includes one or more clasps 108 coupled to the lock ring 102. In some embodiments, two such clasps 108 are disposed on opposing sides the lock ring 102. The opposed clasps 108 may be centered about a central axis 112 of the probe suspension assembly 34 that extends perpendicular to the ring axis 104. A lateral axis 114 of the probe suspension assembly 34 may also be defined that is perpendicular to both the ring axis 104 and the central axis 112.

The lock ring 102 may be a bifurcated lock ring 102a that defines two lock ring segments 102a′ and 102a″. Each of the lock ring segments 102a′ and 102a″ may be coupled to pivot structures 122 that extend from the lock ring segment 102a′ and 102a″ for rotation about a pivot axis 124, defined, for example, by a pivot pin 126. The lock ring segments 102a′ and 102a″ may include free ends 128 opposite the respective pivot structures 122 that can be tangentially separated, and which may be selectively coupled to each other.

Herein, probe holder assemblies 30, probe suspension assemblies 34, lock rings 102 and interior surfaces 106 thereof, and probe housings 36 and exterior surfaces 270 thereof are referred to collectively and generically by their respective reference characters. Specific or individual embodiments of these components and attributes are referenced with a letter suffix (e.g., “probe suspension assembly 34a”).

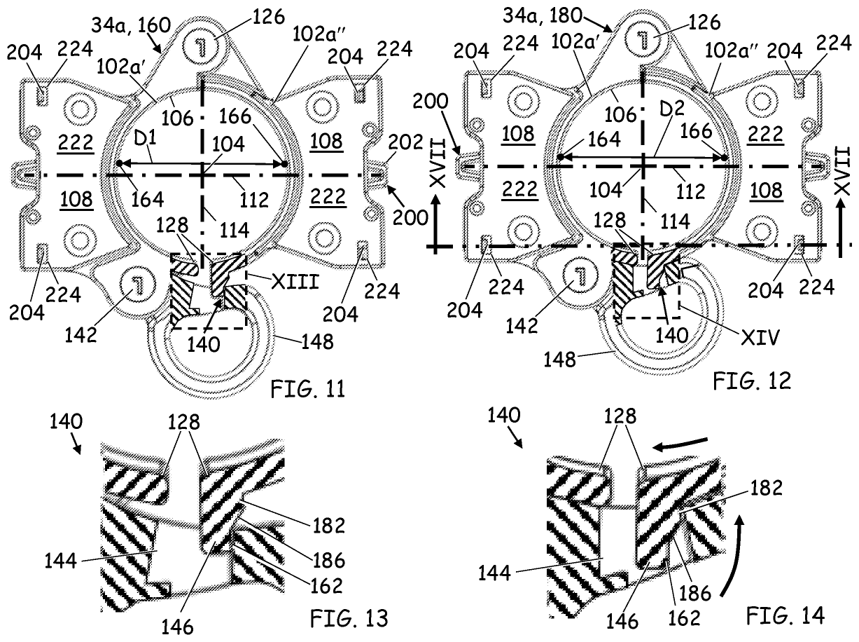

Referring to FIGS. 11 through 14, aspects of the bifurcated lock ring 102a of the probe suspension assembly 34a are further described according to an embodiment of the disclosure. In some embodiments, the free ends 128 are selectively coupled to each other with a catch 140. The catch 140 may be pivotally coupled to one of the lock ring segments 102a′, 102a″, for example with a pivot pin 142. In some embodiments, the catch 140 is pivotally mounted to a first of the lock ring segments 102a′ and selectively attachable to a second of the lock ring segments 102a″. The catch 140 may include a notch 144 and a protrusion 146. In some embodiments, the catch 140 is coupled to a finger loop 148 for actuation.

In some embodiments, the notch 144 and protrusion 146 of the catch 140 are configured to selectively define a partially closed configuration 160 and a fully closed configuration 180. In the partially closed configuration 160 (FIG. 11), the notch 144 engages a first registration surface 162 of the protrusion 146 to define a first maximum separation distance D1 between a midpoint 164 of the first lock ring segment 102a′ and a midpoint 166 of the second lock ring segment 102a″. In the fully closed configuration 180 (FIG. 12), the notch 144 engages a second registration surface 182 of the protrusion 146 to define a second maximum separation distance D2 between the midpoint 164 of the first lock ring segment 102a′ and the midpoint 166 of the second lock ring segment 102a″. In some embodiments, the protrusion 146 includes a transition ramp 186 between the first and second registration surfaces 162 and 182. The first maximum separation distance D1 of the partially closed configuration 160 is greater than the second maximum separation distance D2 of the fully closed configuration 180.

In operation, a probe housing 36a is captured by the bifurcated lock ring 102a in both the partially closed configuration 160 and the fully closed configuration 180. In the partially closed configuration 160, the first maximum separation distance D1 may be sized to enable rotation of the probe housing 36a with little resistance while constraining the probe housing 36a laterally to prevent substantial radial translation within the lock ring segments 102a′ and 102a″. In the fully closed configuration 180, the second maximum separation distance D2 may be configured to firmly clamp the probe housing 36a between the lock ring segments 102a′ and 102a″, thereby maintaining the probe housing 36a in a fixed angular relationship relative to the probe suspension assembly 34a.

Referring to FIG. 15, a probe suspension assembly 34b having a continuous lock ring 102b is depicted according to an embodiment of the disclosure. The probe suspension assembly 34b may include several of the same components and attributes as the probe suspension assembly 34a, some of which are indicated by same-labeled reference characters.

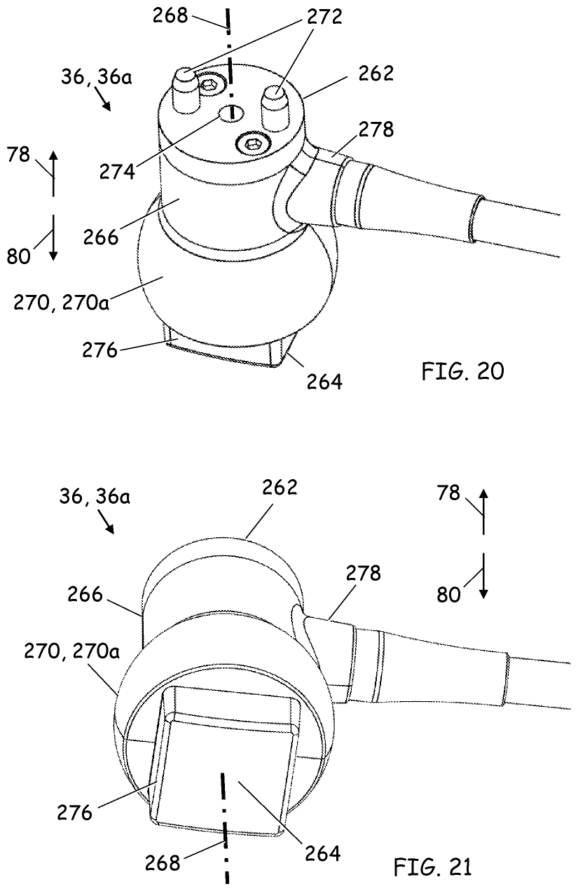

In some embodiments, the continuous lock ring 102b is of sufficient elasticity and resilience to enable structure on an exterior surface of the probe housing 36a (e.g., exterior surface 270, 270a of FIGS. 20 and 21) to pop into the continuous lock ring 102b and maintain sufficient contact thereafter to statically secure the probe housing 36a to the probe suspension assembly 34b by a frictional force. The frictional force may be of a magnitude that can be selectively overcome by hand. In some embodiments, the frictional force is overcome by a torsion applied to the housing 36 about the co-linear ring and probe axes 104 and 268 that exceeds a value that is within a range of 1 to 2.5 Newton-meters inclusive

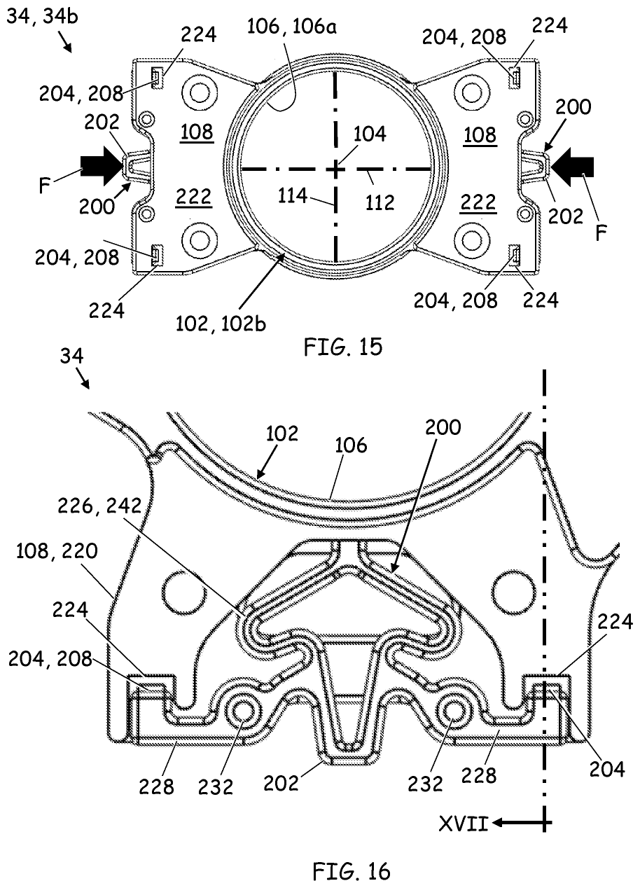

Referring to FIGS. 16 through 19, aspects of the clasp(s) 108 of the probe suspension assemblies 34 are further described according to an embodiment of the disclosure. Each clasp 108 includes an actuation mechanism 200 having a plunger 202 that is coupled to a nib 204 for engaging a locking structure 206 defined by the respective one of the plurality ties 76. The nib 204 may be a detent 208 that engages notches 212 formed on the tie 76. In some embodiments, the locking structure 206 comprises a plurality of the notches 212 to define a serrated profile 214, for example as defined on commercially available ZIP-TIES. Alternative locking structures 206, though not depicted, may be readily implemented by an artisan of ordinary skill in light of the teachings of this disclosure (e.g., through-apertures, perforations, high-friction surfaces), and are considered to be within the scope of this disclosure.

The actuation mechanism 200 may be mounted to a bracket 220 that is attached to the lock ring 102. The bracket 220 may extend radially outward from the lock ring 102. In some embodiments, the actuation mechanism 200 is housed in a closure 222 coupled to the bracket 220. The bracket 220 may be configured to receive one or more of the plurality of ties 76, for example via through-passages 224 defined by the bracket 220, the closure 222, or both, to enable passage of the tic(s) 76 therethrough.

In some embodiments, the actuation mechanism 200 includes a biasing element 226 that biases the nib 204 into engagement with the tie 76. For example, the nib 204 may be disposed on a lever 228 that is coupled to the plunger 202 (depicted). The lever 228 may be pivotally coupled to the bracket 220, for example with a pivot pin 232.

The biasing element 226 may include a flexure 242 that is integral to or unitary with the plunger 202 (depicted). Other biasing elements, though not depicted herein, may be incorporated by an artisan of ordinary skill in light of the teachings of this disclosure (e.g., coil springs, spring arms, leaf springs, resilient blocks) and are considered to be within the scope of this disclosure.

In the depicted embodiments, the clasp 108 is configured to default into engagement with the respective one of the plurality ties 76 and is released upon actuation of the actuation mechanism 200. Alternatively, the actuation mechanism 200 may be arranged to default in a disengaged configuration (not depicted), and to engage and secure the nib 204 to the tie 76 upon actuation. Also in the depicted embodiment, the nib 204 is disposed on the lever 228. Alternatively or in addition, the nib 204 may be affixed to the bracket 220 rather than to the lever 228, and the tie 76 arranged so that the locking structure 206 of the tie 76 engages the bracket 220 (i.e., the nib 204 on the bracket 220) for clasping.

In operation, the biasing element 226 maintains engagement between the nib 204 and the locking structure 206 (FIG. 18) of the tie 76. An actuation force F is applied to depress the plunger 202 radially inward to overcome the biasing of the plunger 202 and to disengage the nib 204 from the tie 76 (FIG. 19). In the depicted embodiment, application of the actuation force F causes the lever 228 to rotate about the pivot pin 232 and away from the tie 76, thereby releasing the nib 204 from the tie 76 and, correspondingly, releasing the probe suspension assembly 34 from the anchor assembly 32.

For embodiments having clasps 108 on opposed sides of the lock ring 102, the plungers 202 may be aligned along an actuation axis 203 so that opposed actuation forces F cancel each other (e.g., FIG. 15), thereby maintaining the probe suspension assembly 34 in equilibrium over the anchor assembly 32 during actuation by an operator. In some embodiments, the actuation axis 203 is parallel to, and may be co-linear with, the central axis 112 of the probe suspension assembly 34a. Disengagement of the nib 204 from the tie 76 enables the probe suspension assembly 34 to be translated axially in the proximal and distal directions 80 and 78 along the positioning axis 64, with the ties 76 passing through the probe suspension assembly 34. When the probe suspension assembly 34 is at a desired axial location along the positioning axis 64, the operator releases the plungers 202, and the biasing element 226 acts to push the plungers 202 radially outward, thereby pivoting the lever 228 about the pivot pin 232 to restore engagement between the nibs 204 and the locking structures 206 of the ties 76.

Functionally, the probe suspension assembly 34 and the anchor assembly 32 cooperate to apply an axial force on the patient during hands-free operation. The hands-free aspect reduces the number of components required to obtain quality ultrasound (e.g., by climination of the handle assembly 42 in the hands-free mode). The iterative, bi-directional positioning of the probe suspension assembly 34 along the positioning axis 64 controls the pressure at the interface of the probe housing 36 and the patient and the attendant distortion to the skin, which may be adjusted for enhancing the ultrasound image quality.

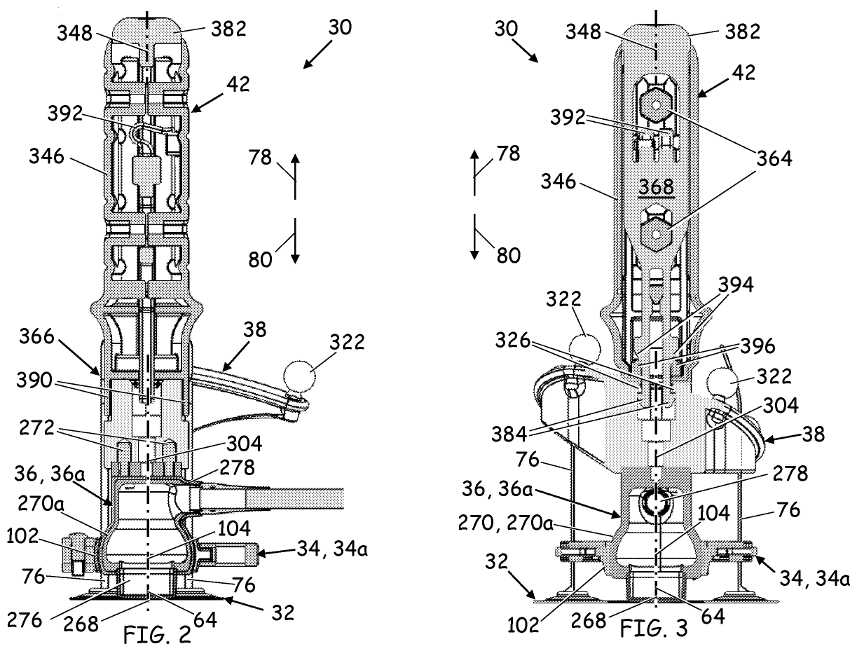

Referring to FIGS. 20 and 21 and again to FIGS. 2 and 3, the probe housing 36 for containment of an ultrasound probe is depicted according to an embodiment of the disclosure. The probe housing 36 includes a proximal end 262 and a distal end 264 separated by a side wall 266. The proximal end 262, distal end 264, and sidewall 266 define and are concentric about a probe axis 268. An exterior surface 270 of probe housing 36 is configured to engage the interior surface 106 of the lock ring 102. The probe housing 36 may be configured for coupling with the lock ring 102 of the probe suspension assembly 34 proximate the distal end 264 of the probe housing 36. In some embodiments, the proximal end 262 includes one or more dowel pins 272 that extend axially in the proximal direction 78 and may include a tap hole 274 configured to receive a fastener (not depicted).

Interior and exterior surfaces 106a and 270a may define complementary profiles for capture of the probe housing 36a within the lock ring 102 of the probe suspension assembly 34. In some embodiments, the profile of an exterior surface 270a of the side wall 266 is convex and the profile of an interior surface 106a of the lock ring 102 is concave (depicted). The complementary profiles of the exterior and interior surfaces 106a and 270a may define arcuate profiles. In some embodiments, the exterior and interior surfaces 106a and 270a define spherical segments.

In some embodiments, the distal end 264 of the probe housing 36 includes an ultrasound lens 276 for directing ultrasonic waves emitted from the ultrasound probe. The ultrasound lens 276 may include a polyamide material. In some embodiments, the ultrasound lens 276 is formed by an injection molding process. The probe housing 36 may include a feedthrough 278 for passage of wires and cabling for the ultrasound probe. In some embodiments, the feedthrough 278 faces radially outward, and may be disposed proximate the proximal end 262 of the probe housing 36.

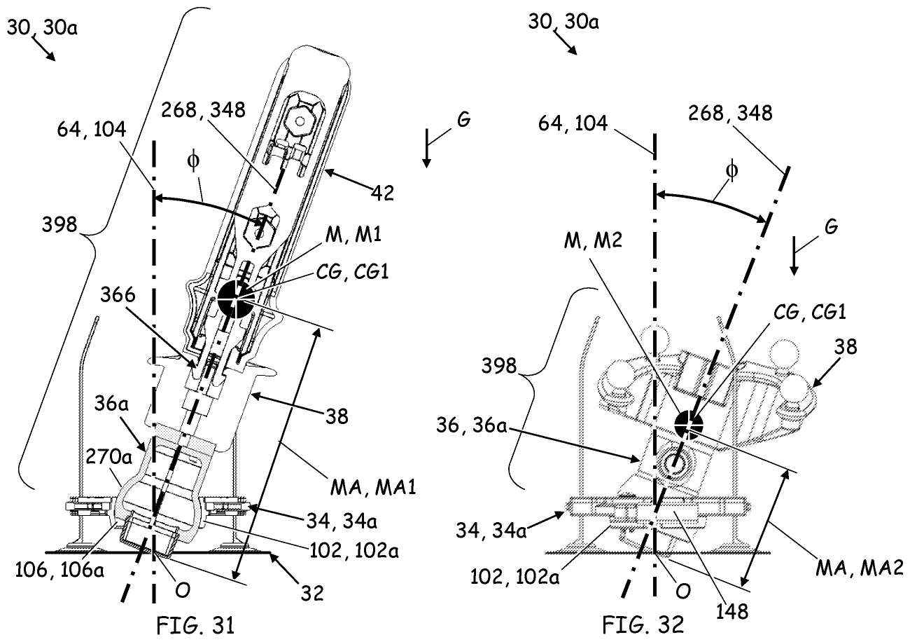

Functionally, the combination of the probe suspension assembly 34 and the probe housing 36 enables “hands-free” ultrasound imaging by holding the probe housing 36 in a desired position and orientation on the patient without application of external forces. Substantially free rotation of the probe housing 36 is enabled about a fixed point on the patient with the probe housing 36 in contact with the patient. For embodiments where the exterior and interior surfaces 106 and 270 define complementary segments that are spherical or otherwise arcuate (e.g., exterior and interior surfaces 106a and 270a), the probe suspension assembly 34 (e.g., 34a) and probe housing 36 (e.g., 36a) act as a gimbal for orienting the probe housing at an arbitrary pitch angle ϕ (FIGS. 31 and 32) about the ring axis 104. A desired location and rotational orientation of the probe housing 36 is secured in place for prolonged periods of time of hands-free ultrasound imaging. The use of non-metallic materials for the components apart from the ultrasound probe reduces metallic artifacts in CT imaging. The location of the feedthrough 278 enables the wires and cabling of the ultrasound probe to be at a distance from the skin of the patient, further reducing metallic artifact in the CT images. The configuration of the proximal end 262 of the probe housing 36 enables secure and precise fixation of components (e.g., the marker assembly 38) to the probe housing 36.

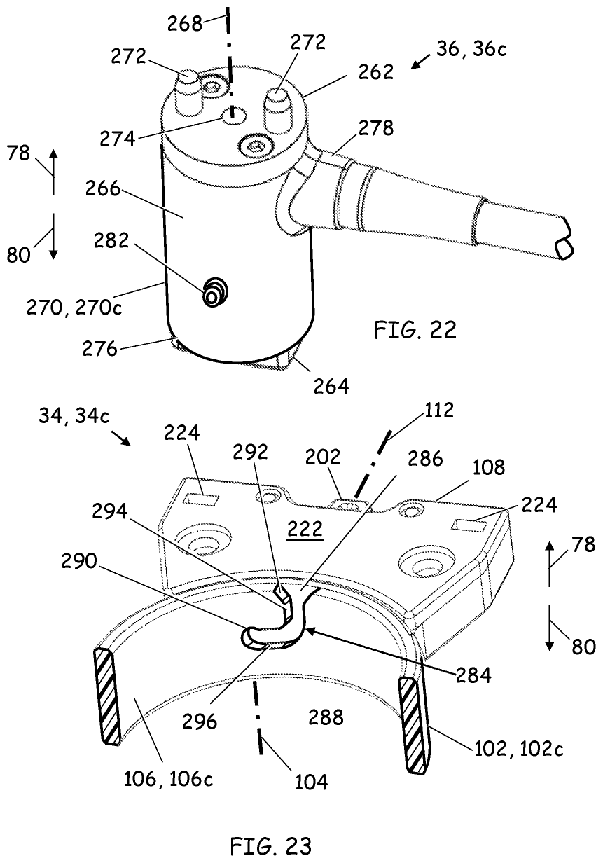

Referring to FIGS. 22 and 23, a probe housing 36c and probe suspension assembly 34c are depicted according to an embodiment of the disclosure. The housing 36c and suspension assembly 34c may include many of the same components and attributes as the probe housing 36a and probe suspension assemblies 34a, 34b, some of which are identified with same labeled reference characters. Distinguishing aspects of the probe housing 36c and a lock ring 102c of the suspension assembly 34c are right cylindrical exterior and interior surfaces 270c and 106c. The lock ring 102c may be a bifurcated structure such as depicted for probe suspension assembly 34a or a continuous structure such as depicted for probe suspension assembly 34b.

In some embodiments, a further distinguishing aspect the probe housing 36c and probe suspension assembly 34c are a lock pin 282 and a lock groove 284. The lock pin 282 may extend radially outward from the exterior surface 270c of the probe housing 36c (depicted), with the lock groove 284 being defined by the interior surface 106c of the lock ring 102c (depicted) and being dimensioned to accept the lock pin 282. Alternatively, in some embodiments (not depicted), the pin and groove structures 282 and 284 may be disposed instead on the lock ring 102c and probe housing 36c, respectively.

In some embodiments, the lock groove 284 defines an access 286 and includes a cam structure 288 that leads to a detent 290. The cam structure 288 may include a lead-in structure 292 at the access 286. The cam structure 288 may define an axial run 294 that leads into a tangential run 296 (depicted) which terminates at the detent 290. Alternatively, the cam structure 288 may define a spiral shape (not depicted) about the ring axis 104 leading to the detent 290.

Only one lock pin 282 and lock groove 284 are depicted in FIGS. 22 and 23. However, a plurality of such lock pins 282 and lock grooves 284 are contemplated. In some embodiments, the plurality of lock pins 282 and lock grooves 284 are uniformly distributed about the ring axis 104 for multiple rotational orientations of the probe housing 36c within the probe suspension assembly 34c. Alternatively, the plurality of lock pins 282 and lock grooves 284 may be non-uniformly distributed about the ring axis 104 for keying the probe housing 36c and probe suspension assembly 34c in a fixed rotational orientation with respect to each other.

In assembly, the probe housing 36c and probe suspension assembly 34c are aligned so that their respective axes 269 and 104 are co-linear and rotated so the lock pin(s) 282 are aligned with the access(es) 286 of the lock groove(s) 284. The probe housing 36c is inserted into the lock ring 102c so that the lock pin(s) 282 enter the lock groove(s) 284. The lock pin(s) 282 may be guided by the cam structure 288 into the detent 290 with a translation and twist action between the probe housing 36c and the lock ring 102c.

Positioning of the access(es) 286 of the lock groove(s) 284 may be arranged to accommodate the feedthrough 278 of the probe housing 36c. That is, for embodiments where the lock groove(s) 284 are defined by the lock ring 102c (depicted in FIG. 23), the access(es) 286 would face in the direction of the feedthrough 278 (i.e., in the proximal direction 78 in FIG. 23). For embodiments where the lock groove(s) 284 are defined by the probe housing 36 (not depicted), the access(es) 286 would face away from the direction of the feedthrough 278 (i.e., in the distal direction 80 of FIG. 22). By these arrangements, the probe housing 36c can be seated within the lock ring 102c without interference from the feedthrough 278.

Functionally, the probe housing 36c and probe suspension assembly 34c define a twist lock arrangement akin to a bayonet connector, wherein the lock pin 282 and the lock groove 284 cooperate to secure the probe housing 36c to the probe suspension assembly 34c. The lock pin 282 is inserted into the lock groove 284 and guided by the cam structure 288 to the detent 290. The lock pin 282 remains registered within the detent 290 by an axial force, for example, a reactive force to the probe housing 36c contacting the patient. The lead-in structure 292 acts to guide the lock pin 282 into the lock groove 284.

Embodiments that do not include the lock pin 282 and lock groove 284 are also contemplated, wherein the probe housing 36c is held secure within the probe suspension assembly 34c by a clamping force exerted by the lock ring 102c (e.g., in a bifurcated ring arrangement) or by friction force between the exterior surface 270c of the probe housing 36c and the interior surface 106c of the lock ring 102c (e.g., in a continuous ring arrangement). The frictional force may be of a magnitude that can be selectively overcome by hand. In some embodiments, the frictional force is overcome by a torsion applied to the probe housing 36c about the co-linear ring and probe axes 104 and 268 that exceeds a value that is within a range of 1 to 2.5 Newton-meters inclusive.

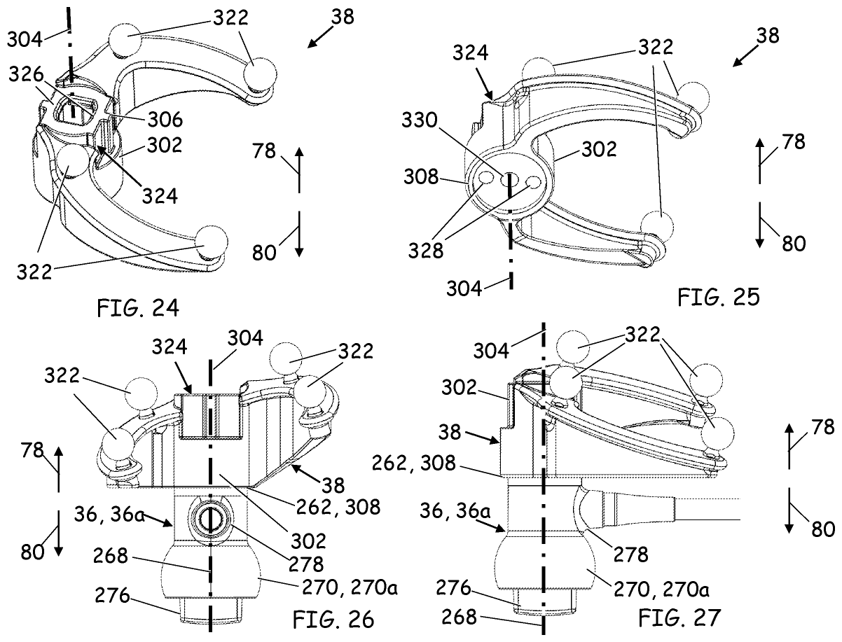

Referring to FIGS. 24 through 27 and again to FIGS. 2 and 3, the marker assembly 38 is depicted according to an embodiment of the disclosure. The marker assembly 38 includes a body portion 302 defining a body axis 304 that extends through a proximal end 306 and a distal end 308, the distal end 308 of the body portion 302 being configured for mounting to the proximal end 262 of the probe housing 36. A plurality of markers 322 is coupled to the body portion 306, the markers 322 being configured for viewing with a camera (not depicted). In some embodiments, the body portion 302 defines or includes a body connector 324 accessible from the proximal end 306. In the depicted embodiment, the body connector 324 presents flange portions 326 for coupling with the handle assembly 42.

The markers 322 may be infrared reflective and the camera an infrared camera. The markers 322 may be arranged in accordance with tracking system protocol specified by a tracking system manufacturer. An example of such a protocol is found at “Polaris Tool Design Guide,” rev. 6, 2018, for the POLARIS® SPECTRA® System manufactured by NDI of Waterloo, Ontario, Canada.

The probe housing 36 and the marker assembly 38 are configured for coupling in a fixed angular relationship about the body axis 304 and maintaining the body axis 304 of the marker assembly 38 and the probe axis 268 of the probe housing 36 in a substantially co-linear arrangement. The distal end 308 of the body portion 302 may define dowel apertures 328 configured to receive the dowel pins 272 of the probe housing 36. Alternatively, the marker assembly 38 may include distally projecting dowel pins that are received by dowel apertures defined by the probe housing 36 (not depicted). In some embodiments, the distal end 308 of the body portion 302 defines a through-aperture 330 for receiving a fastener (not depicted), the through-aperture 330 aligning with the tap hole 274 of the probe housing 36 in assembly.

Functionally, the marker assembly 38 enables placement of active or passive markers 322 for tracking the position of the probe housing 36 with a camera. The arrangement of the markers 322 further enables tracking of the position of the probe housing 36 from a variety of different tracker locations.

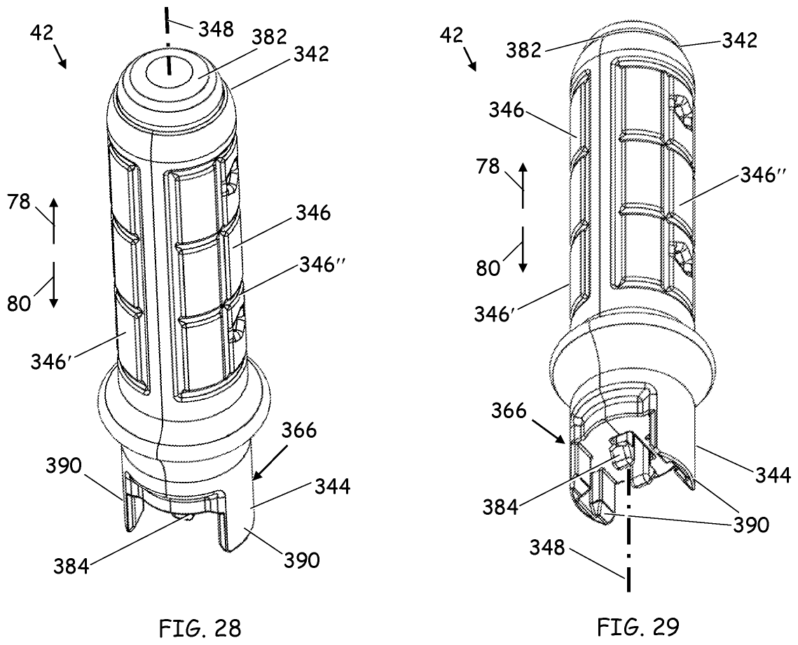

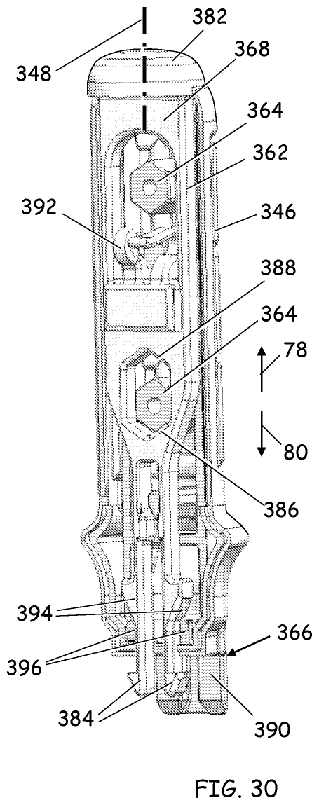

Referring to FIGS. 28 through 30 and again to FIGS. 2 and 3, the handle assembly 42 is depicted according to an embodiment of the disclosure. The handle assembly 42 includes a proximal end 342 and a distal end 344 separated by a casing 346. The proximal end 342, distal end 344, and casing 346 define and are concentric about a handle axis 348. The casing 346 may comprise two casing portions 346′ and 346″ that are joined together to form an interior chamber 362 of the casing 346. One or more bosses 364 may extend from the casing 346 into the interior chamber 362 to receive a fastener (not depicted) for securing the casing portion 346′ to the casing portion 346″.

The distal end 344 includes a handle connector 366 configured to mate with the body connector 324 of the marker assembly 38. In some embodiments, the handle assembly 42 includes a handle plunger 368 that extends from the proximal end 342 and into the distal end 344. The handle plunger 368 may include a push button 382 accessible from the proximal end 342 and which may be actuated, for example, by a thumb or a hand palm of the operator. In some embodiments, the handle connector 366 includes connector features 384 that depend from the handle plunger 368 and extend into or through the distal end 344 of the handle assembly 42, the features 384 being configured to engage the body connector 324 of the marker assembly 38. The handle plunger 368 may include stops 386 that engage the casing 346 to prevent overextension of the handle plunger 368 within the casing 346 in either of the proximal or distal directions 78, 80, for example by way of an opening 388 defined on the handle plunger 368 that engages the boss 364.

The handle connector 366 may include guides 390 for alignment and stability of the connection with the marker assembly 38. In some embodiments, the handle plunger 368 is coupled to the casing 346 with one or more biasing elements 392 to bias the handle plunger 368 in the proximal direction 78. The handle plunger 368 may be configured to deflect the connector features 384 radially inward (i.e., towards the handle axis 348) when actuated in the distal direction 80 within the casing 346, for example by interaction between a ramp 394 structure on the handle plunger 368 and a deflector shoulder 396 coupled to the interior of the casing 346.

In assembly, the probe housing 36 and the marker assembly 38 are secured to each other, for example by a press fit between the plurality of dowel pins 272 and the corresponding dowel apertures 328. In some embodiments, a fastener (not depicted) is inserted into the through-aperture 330 at the distal end 308 of the body portion 302 of the marker assembly 38 and threaded in the tap hole 274 at the proximal end 262 of the probe housing 36, thereby securing the marker assembly 38 to the probe housing 36. In some embodiments, coupling of the probe housing 36 and the marker assembly 38 includes a press fit between the proximal end 262 of the probe housing 36 and the distal end 308 of the body portion 302 of the marker assembly 38.

The probe housing 36 is coupled with the probe suspension assembly 34. For the probe suspension assembly 34a, the probe housing 36 is coupled to lock ring 102 by opening the bifurcated lock ring 102a and securing the probe housing 36 in either the partially closed configuration 160 or the fully closed configuration 180. For the probe suspension assembly 34b, the probe housing 36 is pressed into the continuous lock ring 102b to snap into place. The plurality of ties 76 are fed through the through-passages 224 of the probe suspension assembly 34, for example by depressing the plungers 202 of the probe suspension assembly 34 radially inward. The probe suspension assembly 34 is coupled to the plurality of ties 76 at an arbitrary axial location along the positioning axis 64, for example by releasing the plungers 202.

The handle assembly 42 is coupled to the marker assembly 38, for example by aligning the guides 390 at the distal end 344 of the handle assembly 42 with complementary structures on the marker assembly 38 and inserting the connector features 384 of the hand plunger 368 into the handle connector 366 at the proximal end 306 of the marker assembly 38. The handle assembly 42 is secured to the marker assembly 38, for example by a clipping action that mates the connector features 384 to the body connector 324. The connection may be maintained by the proximal biasing exerted by the biasing elements 392.

In operation, the anchor assembly 32 is adhesively coupled to the patient at a desired anatomical location. An ultrasound gel (not depicted) may be applied on the patient within the aperture 62 of the compliant cover portion 60 for enhanced ultrasound coupling. In some embodiments, an axial positioning procedure includes releasing the probe suspension assembly 34 from the anchor assembly 32 for free and iterative translation of the probe suspension assembly 34 in both the proximal and the distal directions 78 and 80 along the positioning axis 64. The probe suspension assembly 34 is iteratively adjusted in this manner until the probe housing 36 (e.g., the ultrasound lens 276) is at a desired axial location relative to the anchor assembly 32. Determining the desired axial location can involve such free and iterative positioning along with intermittent locking of the probe suspension assembly 34 to the anchor assembly 32 to check the ultrasound image quality without application of an external force (i.c., in a “hands-free” state). In the hands-free state, the plurality of ties 76 are in a state of tension, thereby maintaining the force exerted by the probe housing 36 on the patient.

As explained above, for the depicted embodiments, release of the probe suspension assemblies 34 from the ties 76 of the anchor assembly 32 for free translation along the positioning axis 64 is performed by depression of the plungers 202 radially inward, toward the positioning axis 64. This aspect of the disclosure is non-limiting. An operator or artisan of ordinary skill, in light of the teachings of this disclosure, can configure or operate a probe holder assembly 30 mutatis mutandis that enables free and iterative positioning without actuation of plungers and that locks the probe suspension assembly 34 to the anchor assembly 32 by actuation of plungers or similar structures. As such, the assembly and operation procedures are not limited to the depicted embodiments.

Referring to FIGS. 31 and 32, pitch and rotation adjustment of a probe holder assembly 30a is depicted according to an embodiment of the disclosure. For embodiments utilizing probe housing 36a and probe suspension assembly 34a or 34b, the probe housing 36a can be rotated within the lock ring 102a, 102b and about the ring axis 104 and also oriented at a pitch angle ϕ defined between the ring axis 104 and the probe axis 268. The axial location of the probe suspension assembly 34a, 34b relative to the anchor assembly 32 may remain fixed during the pitch and rotation adjustment. The ring and positioning axes 104 and 64 remain in fixed relationship to each other, and the probe, body, and handle axes 268, 304, and 348 also remain in fixed relationship to each other during the pitch and rotation adjustment.

For the probe suspension assembly 34a, adjustment is made by configuring the bifurcated lock ring 102a in the partially closed configuration 160 (FIGS. 11 and 13). The operator may manipulate the bifurcated lock ring 102a into the partially closed configuration 160 using the finger loop 148 of the probe suspension assembly 34a. In the partially closed configuration 160, the probe housing 36 and marker assembly 38 can be rotated and pitched about the ring axis 104 with little resistance.

For the probe suspension assembly 34b, rotational adjustment of the probe housing 36a is made by overcoming the frictional force between the interior surface 106a of the continuous lock ring 102b and the exterior surface 270a of the probe housing 36a. The handle assembly 42 can facilitate this process. Once the desired pitch and rotation orientations of the probe housing 36a is achieved, the operator simply releases grip on the handle portion. The probe housing 36a is maintained in the released rotational orientation by the frictional forces on the interior and exterior surfaces 106a and 270a.

Once the desired pitch and rotation adjustments are made, the bifurcated lock ring 102a is configured in the fully closed configuration 180 (FIGS. 12 and 14) to secure the probe housing 36 in the desired rotational orientation. The operator may manipulate the bifurcated lock ring 102a into the fully closed configuration 180 using the finger loop 148 of the probe suspension assembly 34a. In the fully closed configuration 180, the probe housing 36 and marker assembly 38 are firmly held in the desired rotational orientation by the bifurcated lock ring 102a.

Having configured the probe housing 36 in the desired position and orientation for operation, the handle assembly 42 may be removed. The handle connector 366 of the handle assembly 42 is decoupled from the body connector 324 of the marker assembly 38 and the handle assembly 42 disengaged. In the depicted embodiment, decoupling of the handle connector 366 is accomplished by depressing the push button 382 into the casing 346, causing the ramps 394 of the handle plunger 368 to engage the deflector shoulders 396 of the casing 346, thereby deflecting the connector features 384 radially inward, toward the handle axis 348 and away from the flanges 326 of the body connector 324. The handle assembly 42 can then be withdrawn in a direction parallel to the handle axis 348.

Any combination of the disclosed probe housings 36, marker assembly 38, and handle assembly 42 are herein referred to as rotatable components 398, where “rotatable” refers to the ability to both rotate about and pitch relative to the positioning axis 64. Returning to FIGS. 31 and 32, removal of the handle assembly 42 has the effect of shifting a center of gravity of the rotatable components 398, as well as reducing the mass associated with that center of gravity. In general terms, the rotatable components 398 that are present for a given configuration can be characterized as establishing an aggregate center of gravity CG, where “aggregate” refers to a given combination of rotatable components 398. The aggregate center of gravity CG is further characterized as being located at a moment arm MA from the origin O of the positioning axis 64 (i.e., the center of the aperture 62 of the compliant cover portion 60). An aggregate mass M is defined as the sum of the masses of the rotatable components 398 and is characterized as being located at the aggregate center of gravity CG. For applications where the positioning axis 64 and the ring axis 104 are not in alignment with a gravity vector G, the gravity vector will cause a moment about the origin O that is proportional to a product of the aggregate mass M and the moment arm MA.

To facilitate the axial positioning and rotational orientation procedures, the handle assembly 42 can be part of the rotatable components 398, establishing a first aggregate center of gravity CG1 of the rotating components that includes the probe housing 36, the marker assembly 38, and the handle assembly 42 (FIG. 31). The first aggregate center of gravity CG1 is located at a first moment arm MA1 from the origin O of the positioning axis 64 (i.e., the center of the aperture 62 of the compliant cover portion 60). An aggregate mass M1 is the sum of the mass of the rotatable components 398 (probe housing 36, marker assembly 38, and handle assembly 42 masses). For applications where the positioning axis 64 and the ring axis 104 are not in alignment with a gravity vector G, the gravity vector will cause a moment about the origin O that is proportional to the first aggregate mass M1 and the first moment arm MA1.

Once the probe housing 36 is fixed at the desired location and orientation, the handle assembly 42 can be removed. Upon removal, a second aggregate center of gravity CG2 is defined at a second moment arm MA2, as well as a second aggregate mass M2 (FIG. 32). Because the handle assembly 42 is removed from the rotatable components 398, both the second moment arm MA2 and the second aggregate mass M2 are reduced relative to the first moment arm MAI and the first aggregate mass M1. As such, any moment about the origin O is reduced by removal of the handle assembly 42.

Functionally, the handle assembly 42 augments manipulation of the probe housing 36 with one hand for adjustment of the ultrasound images. The reduced mass M2 and moment arm MA2 about the origin O of the positioning axis 64 upon removal of the handle assembly 42 reduces the moment that is countered by the anchor assembly 32 and the attendant distortion of the anatomy proximate the contact area of the probe housing 36.

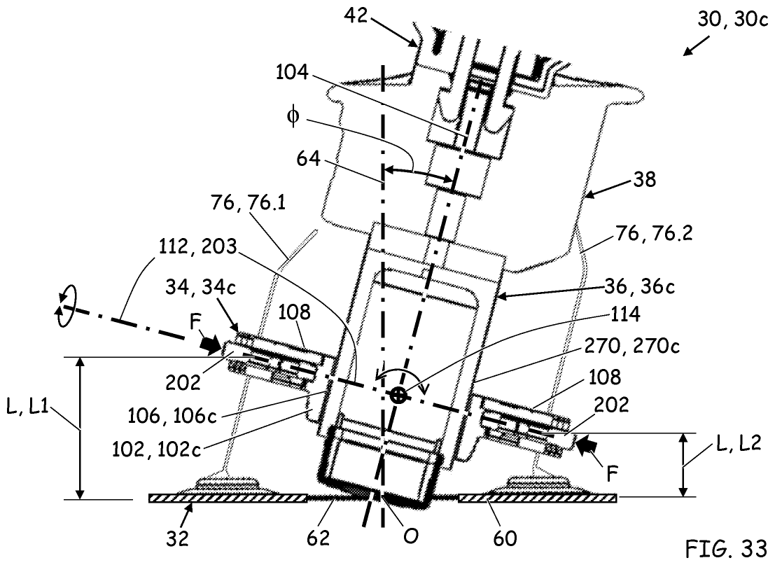

The various assembly and operation procedures described above are not sequentially limited. That is, steps performed in the assembly and operation procedures may be intermingled. For example, the operation steps for mounting the anchor assembly 32 to the patient may occur before the step of coupling the probe suspension assembly 34 to the plurality of ties 76. In another example, steps of the rotational adjustment procedure of the probe housing 36 may intermingle with or incorporate steps of the axial positioning procedure of the probe housing 36. Referring to FIG. 33, a probe holder assembly 30c utilizing tie connection length adjustments to effect the pitch angle ϕ is depicted according to an embodiment of the disclosure. The probe holder assembly 30c includes many of the same components and attributes as the probe holder assembly 30a, which are identified with same labeled reference characters. A distinction of the probe holder assembly 30c is the use of probe suspension assembly 34c having right cylindrical surfaces 106c and 270c. As such, the probe holder assembly 30c does not include a gimbal structure for adjustment of the pitch angle ϕ. Rather, the pitch angle ϕ is established by connection to the various ties 76 at different axial locations L along the positioning axis 64.

The ties 76 are individually identified in FIG. 6 as ties 76.1, 76.2, 76.3 and 76.4, with ties 76.1 and 76.3, as well as ties 76.2 and 76.4, being laterally separated (i.e., separated parallel to the lateral axis 114). In FIG. 33, connection to ties 76.1 and 76.2 at different axial locations L1 and L2, respectively, is illustrated. As a result, the probe suspension assembly 34c is canted between the ties 76.1 and 76.2 to define the pitch angle ϕ of the ring axis 104 relative to the positioning axis 64. This is in contrast to the gimbal structure arrangement of FIGS. 31 and 32, where the pitch angle ϕ is defined between the ring axis 104 and the probe axis 268.

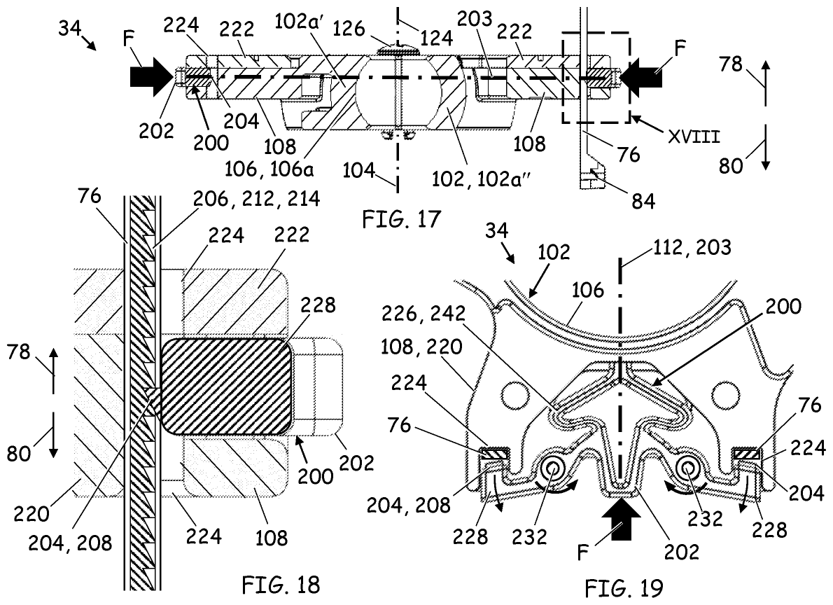

In some embodiments, the clasps 108 are utilized to approximate the different axial locations L1 and L2. The clasps 108 are not visible in the sectional view of FIG. 33 but are depicted in operation at FIGS. 17 through 19. In the depicted embodiment, the plungers 202 are actuated with the opposed actuation forces F and the probe suspension assembly 34c rotated about its lateral axis 114. Actuation of the plungers 202 releases the clasps 108 from the ties 76, enabling substantially free rotation about the lateral axis 114 as the clasps 108 slide along the ties 76. At the desired pitch angle ϕ, the plungers 202 are released or deactivated, causing the clasps 108 to re-engage the ties 76 at the different axial locations L1 and L2, thereby maintaining the pitch angle ϕ.

In some embodiments, alternatively or in addition, the probe suspension assembly 34c may be rotated about its central axis 112 during release of the clasps 108. Different axial locations L are thereby established between laterally adjacent ties 76.1 and 76.3 and laterally adjacent ties 76.2 and 76.4 (identified in FIG. 6). Rotation about the central axis 112 causes the pitch angle ϕ to be defined at planes that are not parallel to the central axis 112.

During the rotations of the probe suspension assembly 34c about the central and/or lateral axes 112, 114, the probe or probe housing 36c may be translated along the ring axis 104 to position or approximately position the distal end 264 of the probe or probe housing 36c within the aperture 62 of the anchor assembly 32. The ties 76 may be pulled taut against the compliant cover portion 60 while maintaining the pitch angle ϕ for enhanced contact between the probe or probe housing 36 and the patient.

Functionally, the tie connection length adjustment technique enables adjustment of the pitch angle ϕ without the complexity of a gimbal structure. The technique can be implemented for lock rings 102c with right cylindrical interior surfaces 106c (depicted), as well as with suspension assemblies that do not include a lock ring at all. Alternatively, the technique may also be used in combination with a gimbal structure (e.g., with probe suspension assembly 34a), for example to provide coarse adjustment of the pitch angle ϕ while using the gimbal structure to fine tune the pitch angle ϕ.

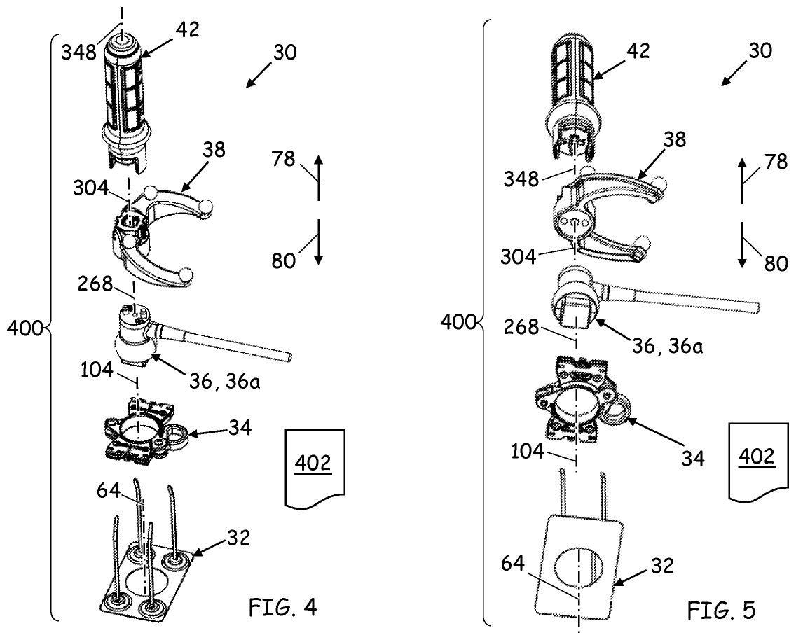

In some embodiments, some or all of the components of the disclosed probe holder assemblies 30 are provided as a kit 400 (depicted at FIGS. 4 and 5). In addition to the components depicted in FIGS. 4 and 5, the kit 400 may also include a probe (not depicted), for example, an ultrasound probe configured for coupling within the probe housing 36. The kit may include instructions 402 for use. The instructions 402 are provided on a tangible, non-transitory medium, and may be physically included with the kit 400 such as on a printed document (depicted), compact disc, or flash drive. Non-limiting examples of a tangible, non-transitory medium include a paper document and computer-readable media including compact disc and magnetic storage devices (e.g., hard disk, flash drive, cartridge, floppy drive). The computer-readable media may be local or accessible over the internet. The instructions 402 may be complete on a single medium or divided among two or more media. For example, some of the instructions 402 may be written on a paper document that instruct the user to access one or more of the steps of the method over the internet, the internet-accessible steps being stored on a computer-readable medium or media. The instructions 402 may embody the techniques and methods depicted or described herein using text, photos, videos, or a combination thereof to instruct and guide the user. The instructions 402 may be in the form of written words, figures, photos, video presentations, or a combination thereof to instruct and guide the user.

The following references are hereby incorporated by reference herein in their entirety: International Patent Application No. WO 2022/136925 to Camps et al., filed Dec. 23, 2021; International Patent Application No. WO 2021/094824 to Camps et al. filed Nov. 11, 2020; International Patent Application No. WO 2019/096943 to Garonna et al., filed Nov. 15, 2018; International Patent Application No. WO 2017/052363 to Tchang, et al.; International Patent Application No. WO 2010/017295 to Vezina; U.S. Patent Application Publication No. 2020/0015780 to Geelen et al.; U.S. Patent Application Publication No. 2020/0178932 to Te Velde et al.; U.S. Patent Application Publication No. 2014/0107435 to Sharf et al.; European Patent No. 0327459 to Puy et al.; U.S. Pat. No. 4,483,344 to Atkov et al.; “Polaris Tool Design Guide,” rev. 6 (NDI, Waterloo, Ontario, Canada 2018). Any incorporation by reference herein of documents above is limited such that no subject matter is incorporated that is contrary to the explicit disclosure herein. Any incorporation by reference of documents above is further limited such that no patent claims included in the documents are incorporated by reference herein. Any incorporation by reference of documents above is yet further limited such that any definitions provided in the documents are not incorporated by reference herein unless expressly included herein.

Each of the additional figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant arts will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112 (f) are not to be invoked unless the specific terms “means for” or “step for” are recited in the respective claim.

1-52. (canceled)

53. A probe holder assembly, comprising:
a probe suspension assembly:
an anchor assembly coupled to the probe suspension assembly, the anchor assembly comprising a compliant cover portion configured to be adhesively coupled to an anatomical location of a patient;
a probe housing comprising an ultrasound probe, the probe housing comprising a proximal end and a distal end separated by a side wall having an exterior surface; and
a marker assembly comprising:
a body portion defining a body axis that extends through a proximal end and a distal end, the distal end of the body portion extending from the proximal end of the probe housing, and
a plurality of markers coupled to the body portion, the plurality of markers configured to be viewed with a camera,
wherein the probe suspension assembly is configured to couple to the probe housing in a fixed angular relationship.

54. The probe holder assembly of claim 53, wherein the compliant cover portion defines an aperture configured to permit passage of the distal end of the probe housing.

55. The probe holder assembly of claim 53, wherein the plurality of markers are configured for one of active emission or passive reflection.

56. The probe holder assembly of claim 53, wherein the camera comprises an infrared camera and the plurality of markers are configured to be detected by the infrared camera.

57. The probe holder assembly of claim 53, further comprising a handle assembly having a distal end configured to be selectively coupled to the proximal end of the marker assembly.

58. A probe holder assembly, comprising:
a marker assembly comprising:
a body portion defining a body axis that extends through a proximal end and a distal end, the distal end of the body portion extending from a proximal end of a probe housing comprising an ultrasound probe, and
a plurality of markers coupled to the body portion, the plurality markers configured to be viewed with a camera; and
a handle assembly having a distal end configured to be selectively coupled to the proximal end of the marker assembly.

59. The probe holder assembly of claim 58, wherein:
the marker assembly includes a first connector at the proximal end of the body portion;
the handle assembly includes a second connector at the distal end of the handle assembly; and
when fully engaged, the first connector and the second connector maintain the marker assembly and the handle assembly in a fixed axial and rotational relationship.

60. The probe holder assembly of claim 59, wherein the first connector is unitary with the body portion of the marker assembly.

61. The probe holder assembly of claim 59, wherein the first connector and the second connector include a polygonal interface to maintain the rotational relationship.

62. The probe holder assembly of claim 59, wherein the handle assembly is configured to translate axially for coupling the second connector to the first connector.

63. The probe holder assembly of claim 59, wherein one of the first and second connectors is female and the other is male.

64. A method for positioning a probe on a patient for hands-free operation, the method comprising:
providing a kit including an anchor assembly, a probe suspension assembly, and a probe housing; and
providing instructions on a tangible, non-transitory medium, the instructions comprising:
adhesively coupling a compliant cover portion of the anchor assembly to an anatomical location of the patient;
depressing a plunger mechanism on the probe suspension assembly to freely position the probe housing along a positioning axis of the anchor assembly; and
actuating the plunger mechanism on the probe suspension assembly to couple the probe suspension assembly to the probe housing in a desired contact condition with the anatomical location of the patient.

65. The method of claim 64, wherein the instructions provided in the step of providing instructions includes:
during the step of depressing the plunger mechanism, rotating the probe housing about a lateral axis of the probe suspension assembly to define a pitch angle of the probe housing relative to the positioning axis, said lateral axis being orthogonal to an actuation axis of said opposed plunger mechanisms.

66. The method of claim 64, wherein the instructions provided in the step of providing instructions includes:
during the step of depressing the plunger mechanism, rotating the probe housing about a central axis of the probe suspension assembly to define a pitch angle of the probe housing relative to the positioning axis.

67. The method of claim 66, wherein, the instructions provided in the step of providing instructions includes:
during the step of depressing the plunger mechanism, rotating the probe housing about a lateral axis of the probe suspension assembly to define, the pitch angle of the probe housing relative to the positioning axis.

68. (canceled)

69. The method of claim 64, wherein the probe housing is coupled to the probe suspension assembly in the step of providing the kit.

70. The method of claim 64, wherein the instructions in the step of providing instructions includes coupling the probe housing to the probe suspension assembly.

71. A method for orienting a probe on a patient for hands-free operation, the method comprising:
providing a kit comprising a probe suspension assembly and a probe housing comprising an ultrasound probe; and
providing instructions on a tangible, non-transitory medium, the instructions comprising:
configuring a lock ring of the probe suspension assembly in a partially closed configuration;
rotating the probe housing within the probe suspension assembly into a desired orientation; and
configuring the lock ring in a fully closed configuration to secure the probe housing in the desired orientation.

72. The method of claim 71, wherein the step of rotating the probe housing includes defining a non-zero pitch angle between a probe axis of the probe housing and a ring axis of the probe suspension assembly.

73. The method of claim 71, comprising executing the instructions provided in the step of providing instructions.

74. The probe holder assembly of claim 53, wherein the probe suspension assembly further comprises a locking structure.

75. The probe holder assembly of claim 74, wherein the locking structure comprises a plurality of notches.
